(19) United States
(12) Patent Application Publication
(10) Pub. No.: US 2026/0326894 A1
(43) Pub. Date: Oct. 22, 2026

(54) METHOD FOR TAXIING AN AIRCRAFT COMPRISING A DRIVE MEMBER EQUIPPING A WHEEL CARRIED BY A LANDING GEAR OF THE AIRCRAFT

(71) Applicant: SAFRAN LANDING SYSTEMS, Velizy Villacoublay (FR)

(72) Inventors: Dominique ONFROY, Moissy-Cramayel (FR); Jean-Philippe JOIGNET, Moissy-Cramayel (FR); Jean-Philippe VASLIN, Moissy-Cramayel (FR)

(73) Assignee: SAFRAN LANDING SYSTEMS, Velizy Villacoublay (FR)

(21) Appl. No.: 19/115,039

(22) PCT Filed: Sep. 26, 2023
(86) PCT No.: PCT/EP2023/076447

§ 371 Date: Mar. 25, 2025

(30) Foreign Application Priority Data
Sep. 26, 2022 (FR) FR2209719

(51) Int. Cl. B64C 25/32

(52) U.S. Cl. CPC B64C 25/405

(57) ABSTRACT

A method for taxiing an aircraft by pre-empting when a drive member provided in one or more wheels born by a landing gear of the aircraft is unable to move the aircraft on the ground includes determining one or more of the following values: a minimum required traction force needed by the drive member to move the aircraft, a maximum transmissible traction force that can be transmitted to the ground by grip via the wheel, and heating of the drive member, comparing each value with a predetermined threshold, and deducing from the comparison whether the drive member is able to move the aircraft.

The present invention relates to moving an aircraft on the ground, and more particularly to a method for determining whether a drive member is able to move the aircraft on the ground, the drive member being provided in a wheel borne by a landing gear of the aircraft.

### BACKGROUND OF THE INVENTION

Traditionally, aircraft are moved on the ground using their main engines (propeller or jet engines). To reduce the environmental damage associated with using aircraft, it is envisaged to provide said aircraft with a device for rotating the landing gear wheels in order to allow the aircraft to be moved on the ground without using their main engines. The drive device comprises a drive member associated with at least one wheel of one of the landing gears, and coupling means for selectively coupling and uncoupling an output shaft of the motor to/from a rim of the wheel. The shaft and the rim are coupled together during the taxiing phases and uncoupled during the take-off and landing phases and when the aircraft is in flight. The drive member comprises an electric motor and is connected to an electric generator driven by an auxiliary engine (or APU) of the aircraft and/or to batteries.

With a drive device of this kind, the fuel consumption required for moving the aircraft on the ground can be reduced. This results in financial benefits, a significant reduction in emissions of carbon dioxide (CO₂), nitrogen oxide (Noₓ) and fine particles, and a reduction in noise in airport areas.

The drive device is generally sized such that it can move the aircraft at a maximum speed of 20 knots with a mass substantially equal to the maximum permitted mass of the aircraft at take-off, regardless of the type and characteristics of the ground (the material, e.g. bitumen, asphalt, macadam or concrete, and the surface, e.g. the slope, the presence of bumps or other irregularities, etc.) and the downtime or stop time of the aircraft.

Drive devices of this kind are bulky and particularly heavy (mass in the order of several hundred kilograms), which can overburden the payload of the aircraft and cancel out the financial and environmental benefits deriving from the drive device (excess consumption of fuel outside the taxiing phases).

### OBJECT OF THE INVENTION

The object of the invention is to propose a means for optimising the taxiing of aircraft.

### SUMMARY OF THE INVENTION

It is envisaged to size the drive device in such a way as to cover a majority of operating scenarios but not all of them, thus disregarding low-probability conditions that would lead to the drive device being oversized. In this regard, it is beneficial to pre-empt when the drive device is unable to cover these low-probability conditions and therefore when alternative means are needed to move the aircraft on the ground (pushback tractors, main engines of the aircraft, etc.) so as not to disrupt the operation of the aircraft and the organisation of the airport areas. However, a pushback tractor might not necessarily be available near the aircraft, and also the pilot's reconfiguration of movement provided by the drive device into movement provided by the main engines of the aircraft cannot happen immediately because of the start time required to obtain sufficient thrust.

To this end, the invention proposes a method for taxiing aircraft by pre-empting when a drive member provided in at least one wheel borne by a landing gear of an aircraft is unable to move said aircraft on the ground. The method comprises the following steps:
a) determining at least one of the following values: a minimum traction force to be developed by the drive member in order to move the aircraft, a maximum transmissible traction force that can be transmitted to the ground by grip via the wheel, and heating of the drive member;
b) comparing each value with a predetermined threshold;
c) deducing from this comparison whether the drive member is able to move the aircraft.

Being able to pre-empt when the drive member is unable to move the aircraft (in an ongoing taxiing situation or in a situation moving off from a stationary position) makes it possible to provide a pushback tractor or the use of the main engines to assist with the taxiing of the aircraft.

In particular, the drive member is sized so as to be able to move the aircraft only in a majority of operating scenarios but not all of them, thereby allowing its mass and, to a lesser extent, its volume to be reduced.

According to a particular feature of the invention, the minimum required traction force is determined from at least one of the following parameters: the mass of the aircraft, the type of ground, the slope of the ground, the ambient temperature and the stop time of the aircraft.

In particular, the minimum required traction force is determined from charts or equations that relate the mass of the aircraft and the slope of the ground to the minimum required traction force depending on the type of ground, the ambient temperature and the stop time of the aircraft.

According to another particular feature of the invention, the maximum transmissible traction force that can be transmitted by grip is determined from at least one of the following parameters: a load exerted by the mass of the aircraft on the wheel, ground conditions.

In particular, the maximum transmissible traction force is determined from charts or equations that relate the load exerted by the mass of the aircraft on the wheel to said maximum transmissible traction force depending on the ground conditions.

According to another particular feature of the invention, the heating of the drive member is determined from the temperature of at least one critical element of the drive member.

According to another particular feature of the invention, the threshold with which the minimum required traction force is compared corresponds substantially to the maximum torque deliverable by the drive member.

According to another particular feature of the invention, the threshold with which the maximum transmissible traction force is compared corresponds substantially to the minimum required traction force.

In particular, the drive member comprises a plurality of actuators, and the threshold with which the minimum and/or maximum traction force is/are compared is adjusted depending on the number of available actuators.

### BRIEF DESCRIPTION OF THE DRAWINGS

The invention will be better understood in the light of the following description, which is purely illustrative and non-limiting and should be read with reference to the accompanying drawings, in which:

FIG. 1 is a schematic view of an aircraft comprising an auxiliary landing gear bearing wheels which have a drive member for moving the aircraft on the ground;

FIG. 2 is a view showing a method according to the invention for pre-empting when the drive member is unable to move the aircraft on the ground;

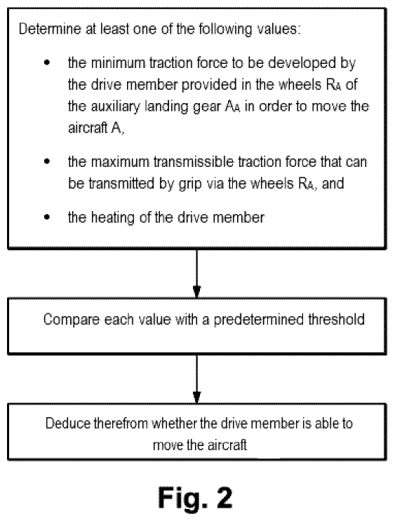

FIG. 3 is a view showing charts used to determine, in accordance with the method according to the invention, the minimum required traction force to be developed by the drive member in order to move the aircraft shown in FIG. 1; and

FIG. 4 is a view showing charts used to determine, in accordance with the method according to the invention, a maximum transmissible traction force that can be transmitted by the wheels of the auxiliary landing gear of the aircraft shown in FIG. 1.

### DETAILED DESCRIPTION OF THE INVENTION

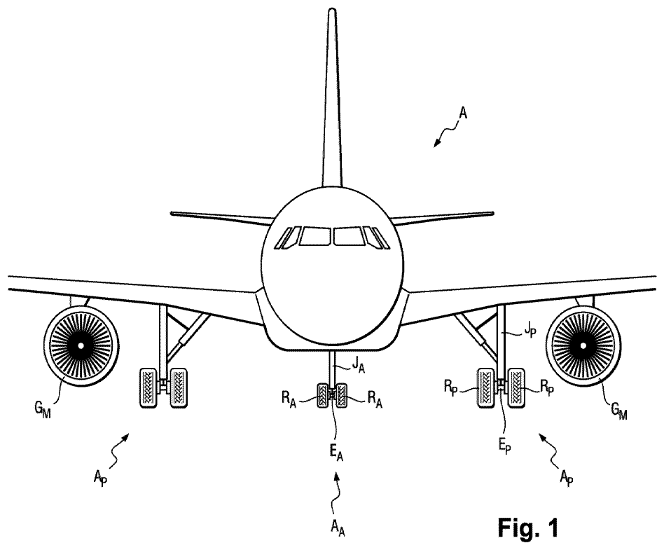

With reference to FIG. 1, an aircraft A comprises main engines (power plants G_{M} such as propeller engines, e. g. turboprop engines, or turbojet engines), two main landing gears A_{P} and one auxiliary landing gear A_{A}.

Each of the main landing gears A_{P} comprises a strut J_{P} having a first end rigidly connected to a structure S of the aircraft A and, on the opposite side, a second end bearing two wheels R_{P} pivotally received on an axle E_{P}. Each of the wheels R_{P} comprises a rim receiving a tyre. The strut J_{P} comprises a chamber hinged to the structure of the aircraft A, and a rod mounted slidably along an axis that is substantially perpendicular to the pivot axis of the wheels R_{P} to form a damper. At a lower end, the rod bears the axle E_{P}, which pivotally receives the wheels R_{P}. The axle E_{P} is rigidly connected to the rod such that said axle E_{P} is immovable relative to said rod.

In addition, each of the wheels R_{P} has a brake. As is known per se, the brake comprises a stack of discs that is received in an annular space delimited by the rim and that comprises, alternately, stator discs, which are non-rotatable relative to the axle E_{P}, and rotor discs, which are non-rotatable relative to the rim. Hydraulic or electromechanical cylinders are arranged to exert a pressure force on the stack of discs.

Similarly, the auxiliary landing gear A_{A} comprises a strut J_{A} having a first end rigidly connected to a structure S of the aircraft A and, on the opposite side, a second end bearing two wheels R_{A} pivotally received on an axle E_{A}. Each of the wheels R_{A} comprises a rim receiving a tyre. The strut J_{A} comprises a chamber hinged to the structure of the aircraft A, and a rod mounted slidably along an axis that is substantially perpendicular to the pivot axis of the wheels R_{A} to form a damper. At a lower end, the rod bears the axle E_{A}, which pivotally receives the wheels R_{A}. The axle E_{A} is rigidly connected to the rod such that said axle E_{A} is immovable relative to said rod.

The axle E_{A} has a device for rotating the wheels R_{A}, said device being intended for moving the aircraft A when it is on the ground (without using its power plants G_{M}). The drive device comprises a drive member, which here comprises an electric motor combined with a reduction gear, an output shaft of which is selectively rotatably connected to the wheels R_{A}. The electric motor is powered by an electric network connected to an auxiliary power unit—here an electric generator rotated by an auxiliary engine (or APU) of the aircraft A.

According to the invention, the drive member is sized so as to deliver a maximum torque capable of ensuring a sufficient traction force to move the aircraft A in a majority of operating scenarios but not all of them. Here, low-probability operating scenarios are disregarded when sizing the drive member, thereby preventing the drive member from being oversized and thus allowing its mass and, to a lesser extent, its volume to be minimised. Low-probability operating scenarios correspond, for example, to a particularly high mass of the aircraft A and/or to atypical ground conditions (significant gradient, large obstacle under the wheel, particularly low ground rigidity, etc.). In particular, they can be determined on the basis of a predefined maximum mass for a typical deployment or in relation to a target maximum mass (or volume) in order to allow the drive member to be integrated in the aircraft A.

The traction force required to move the aircraft A on the ground depends in particular on:
the mass of the aircraft A;
the type of ground (nature of the ground surfacing, presence of obstacles, bumps, etc.);
the slope of the ground;
the stop time (or downtime) of the aircraft A; and
the ambient temperature (which influences the temperature of the ground) and the temperature of the tyres of the wheels R_{A}, R_{P}.

The required traction force also depends on the load exerted on the wheels R_{A}, R_{P}, said load itself depending in particular on the mass of the aircraft A and the slope of the ground.

When the aircraft A is on the ground, its mass can be determined using a system that delivers, for each of the landing gears A_{A}, A_{P}, a signal representative of a penetration of the rod into the chamber, the system being connected to an on-board processing unit. It can also be directly input by the pilot of the aircraft A or the ground crew using a human-machine interface (HMI) connected to the processing unit, for example via a radio link. It can also be estimated in advance on the basis of information supplied by the pilot of the aircraft A or the ground crew via the human-machine interface (mass at the start of the flight, flight time or distance, type of flight, etc.) ; this information allows the processing unit to determine a fuel consumption of the power plants G_{M} (in other words, a mass reduction during flight) and to deduce therefrom a mass of the aircraft A after landing. In a simple implementation, the human-machine interface comprises a terminal that interfaces with the pilot in the cockpit of the aircraft A. In a more advanced implementation, the human-machine interface comprises two terminals: one interfacing with the pilot in the cockpit, the other interfacing with the ground crew via a dedicated tool. The ground crew can then be responsible for managing a pushback tractor that is able to move the aircraft A if necessary.

The type of ground can be determined using an on-board system, for example an optical system pointing towards the ground, the system being connected to the processing unit. It can also be directly input by the pilot of the aircraft A or the ground crew using the human-machine interface. One alternative is to use a ground map of the airport in question that lists the different types of ground, as well as coordinates representative of a position of the aircraft A on the map.

The slope of the ground can be determined using an on-board system that measures the attitude of the aircraft A and, for each of the landing gears A_{A}, A_{P}, the penetration of the rod into the chamber, the on-board system being connected to the processing unit. It can also be directly input by the pilot of the aircraft A or the ground crew using the human-machine interface. If these data are unavailable (for example if the on-board system is absent or has malfunctioned), the processing unit may use a default slope value. One alternative is to use a map of the slope of the ground for the airport in question, coordinates representative of a position of the aircraft A on the map and information representative of an orientation of the aircraft A.

The stop time can be determined by the processing unit on the basis of data representative of the speed of the aircraft A or of the activation of the brakes of the aircraft A. If these data are unavailable (for example during a power-down of the aircraft A during a long stop), it can be input by the pilot of the aircraft A or the ground crew using the human-machine interface (for example by indicating a departure of the aircraft A after a long stop). The processing unit can also use a default stop time.

The ambient temperature and the temperature of the tyres can be determined using a dedicated on-board system, the system being connected to the processing unit. The ambient temperature can also be supplied to the processing unit by a service external to the aircraft A that provides information on the weather conditions.

From at least one of these pieces of information (mass of the aircraft A, type of ground, slope of the ground, stop time of the aircraft, ambient temperature), the processing unit determines the minimum required traction force 101 needed to move the aircraft A on the ground and compares it with a predetermined threshold 102 corresponding to the maximum torque deliverable by the drive member. Where the minimum required traction force 101 is less than equal to the predetermined threshold 102, the processing unit indicates via the human-machine interface that the drive device is able to move the aircraft A on the ground. Otherwise, i.e. when the minimum required traction force 101 is greater than the predetermined threshold 102, the processing unit indicates via the human-machine interface that the drive device is not able to move the aircraft A on the ground, thereby allowing the pilot or the ground crew to use alternative means to move said aircraft A (use of a pushback tractor for the manoeuvring phases or power plants G_{M} for the taxiing phases).

The minimum required traction force 101 can be determined from predefined charts or equations (or more advanced models) stored by the processing unit.

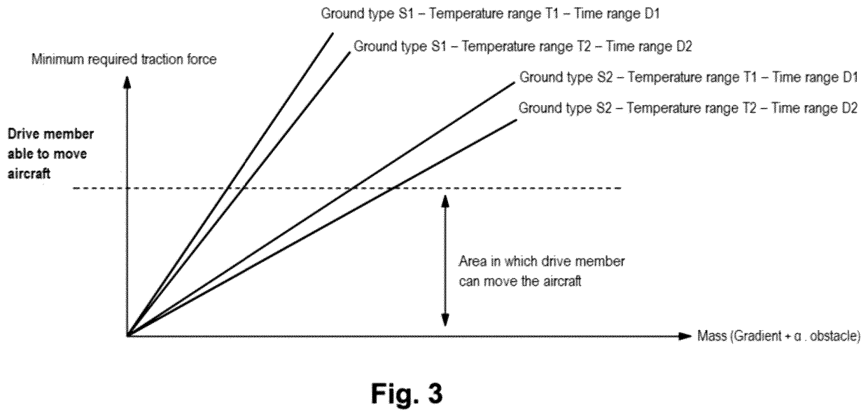

FIG. 3 shows an example of charts used by the processing unit to determine the minimum required traction force 101. This example relates, for a given slope (or gradient) of the ground and a given obstacle, the mass of the aircraft A to the minimum required traction force 101 depending on the type of ground surfacing, the ambient temperature and the stop time of the aircraft A. In this example, the reference a is a coefficient that is a function of a height of the obstacle, and there are:
two types of surfacing: a first type Si corresponding to a flexible ground (e.g. asphalt) and a second type S₂ corresponding to a rigid ground (e.g. concrete) ;
two temperature ranges: a first range T₁ corresponding to a temperature greater than or equal to 30 °C and a second range T₂ corresponding to a temperature less than 30 °C;
two ranges for the stop time of the aircraft A: a first range D₁ corresponding to a time greater than or equal to one hour and a second range D₂ corresponding to a time less than one hour.

It goes without saying that the number of charts can be increased, for example by taking into account other parameters (tyre pressure and wear, etc.) or by increasing the number of surfacing types and/or the number of temperature ranges and/or the number of stop time ranges.

The equations relate the minimum required traction force 101 to the mass of the aircraft A, the type of ground, the slope (or gradient) of the ground, the stop time of the aircraft A and the ambient temperature. For example, the minimum required traction force 101 is determined from one of the following two equations:

Minimum required traction force 101=(β+gradient+δ.obstacle)×mass (1)

Minimum required traction force 101=(β+gradient)×mass+δ′.obstacle (2)

where:
βis a function of the temperature, the stop time of the aircraft A and the type of ground surfacing; and
δ, δ′ is a function of the height of the obstacle or a Boolean value indicating whether or not the obstacle is present.

Using equations rather than charts allows continuous and non-discretised parameters to be used; for the stop time of the aircraft A, the gradient of the chart is calculated, for example, by one continuous function of the stop time of the aircraft A instead of using two charts of different gradients corresponding to two stop time ranges.

Irrespective of the intrinsic features of the drive member, the grip conditions may be a factor limiting the maximum transmissible traction force 201 that can be transmitted by the wheels R_{A} of the auxiliary landing gear A_{A}.The maximum transmissible traction force 201 depends in particular on:
the loading of the auxiliary landing gear A_{A} (the transmissible traction force is directly proportional to the weight exerted on the driven wheels R_{A}) ; and
the ground conditions (dry, wet, snow-covered, contaminated with de-icing agent, oil, etc.) .

When the aircraft A is on the ground, the loading of the auxiliary landing gear A_{A} can be determined by the processing unit by means of the system that delivers the signal representative of the penetration of the rod into the chamber. It can also be directly input by the pilot of the aircraft A or the ground crew using the human-machine interface.

The ground conditions can be determined by the processing unit using the optical system pointing towards the ground. They can also be supplied to the processing unit by a service external to the aircraft A that provides information on the weather conditions.

From this information (loading of the auxiliary landing gear A_{A} and ground conditions), the processing unit determines the maximum transmissible traction force 201 that can be transmitted via the wheels R_{A} of the auxiliary landing gear A_{A} and compares it with a predetermined threshold 202, which in this case corresponds to the minimum required traction force 101 needed to move the aircraft A. Where the maximum transmissible traction force 201 is greater than or equal to the predetermined threshold 202, the processing unit indicates via the human-machine interface that the drive device is able to move the aircraft A on the ground. Otherwise, i.e. when the maximum transmissible traction force 201 is less than the predetermined threshold 202, the processing unit indicates via the human-machine interface that the drive device is not able to move the aircraft A on the ground, thereby allowing the pilot or the ground crew to use alternative means to move said aircraft A (use of a pushback tractor for the manoeuvring phases or po plants for the taxiing phases).

The maximum transmissible traction force 201 can be determined from predefined charts or equations stored by the processing unit.

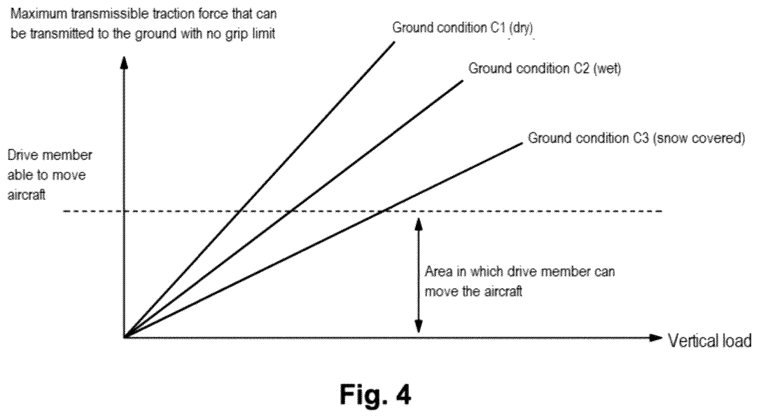

FIG. 4 shows an example of charts used by the processing unit to determine the maximum transmissible traction force 201. This example relates the loading of the auxiliary landing gear A_{A} to the maximum transmissible traction force 201 depending on the ground conditions. In this example, there are three different ground conditions:
a first ground condition C₁ corresponding to dry ground;
a second ground condition C₂ corresponding to wet ground; and
a third ground condition C₃ corresponding to snow-covered ground.

It goes without saying that the number of charts can be increased, for example by taking into account other parameters (tyre pressure and wear, etc.) or by increasing the number of ground conditions (icy, contaminated with de-icing agent, oil, etc.).

According to the invention, the drive member is also sized so as to withstand, during operation, the maximum heating for moving the aircraft A in the majority of operating scenarios but not all of them. In this regard, low-probability operating scenarios, in particular operating scenarios that require operation at high power for a very long period, are not taken into account when sizing the drive member so as to avoid oversizing the drive member and therefore to minimise its mass.

When the motor is in operation, the processing unit determines, via temperature sensors or depending on control parameters f the drive member (for example the supply current of the motor), the heating 301 of different critical elements of the drive member (motor, electronics, intermediate gear, etc.) and compares it, for each critical element, with a first predetermined threshold TC₁ and a second predetermined threshold TC₂. The first threshold TC₁ corresponds to the maximum permitted heating for the critical element in question less a first margin m₁, and the second threshold TC₂ corresponds to the maximum permitted heating for the critical element in question less a second margin m₂. The first margin m₁ is greater than the second margin m₂, and so the second threshold TC₂ is higher than the first threshold TC₁.

When the temperature of at least one of the critical elements reaches the first associated threshold TC₁, the processing unit indicates to the pilot, via the human-machine interface, that the drive member has a limited remaining heating capacity and therefore an operating capacity limited to a length of time permitted by the first margin m₁; this allows the pilot to use alternative means to continue moving said aircraft A after the length of time permitted by said first margin m₁ (use of a pushback tractor, in particular for the manoeuvring phases, and/or of power plants G_{M}, in particular for the taxiing phases).

Once the temperature of the critical element in question reaches the second threshold TC₂, the drive member is deactivated. This deactivation can be automatic or controlled by the pilot. The need to use the power plants G_{M} may also be based on the knowledge of the deployment carried out by the aircraft A.

Examples showing how the inability of the drive member to move the aircraft A is determined as described above will now be set out. In these examples, the human-machine interface indicates to the pilot that the drive member is unable to move the aircraft in the form of a light that can display three colours:
Green: drive member functional, no need to provide alternative means to move the aircraft A;
Yellow: drive member functional, alternative means to be provided in the near term to move the aircraft A;
Red: drive member unavailable, alternative means essential.

### Example 1

Before leaving a boarding gate, the pilot inputs the mass of the aircraft A, which in this example is average, into the human-machine interface. The processing unit also receives the following parameters from the ground crew via the human-machine interface: rigid ground, zero gradient (known data from the boarding gate), dry runway with no obstacles under the aircraft wheels in its parking position (visual check), move-off scheduled after a one-hour stop.

For these conditions, the processing unit determines that the drive member is able to move the aircraft. This information is indicated to the pilot and ground crew via the human-machine interface, which displays a green light. The pilot or ground crew do not use alternative means (pushback tractor).

### Example 2

Before leaving a boarding gate, the pilot inputs the (confirmed or expected) mass of the aircraft A, which in this example is high, into the human-machine interface. The processing unit also receives the following parameters from the ground crew via the human-machine interface: rigid ground, significant gradient in the moving-off direction (known data from the boarding gate), dry ground with no obstacles under the aircraft wheels in its parking position (visual check), move-off scheduled after a 12-hour stop.

For these conditions, the processing unit determines that the drive member is unable to move the aircraft A. This information is indicated to the pilot and ground crew via the human-machine interface, which displays a red light. The ground crew use an alternative means (pushback tractor) to move the aircraft, without having to wait to confirm that this is needed at the actual departure time. It should be noted that from the parameters entered by the ground crew via the human-machine interface, the processing unit can determine the maximum mass at which it is possible to move the aircraft A using the drive member and inform the pilot of this operational limitation, allowing the pilot to know what margin they have.

Example 3

When the aircraft A is taxiing on a taxiway (a runway used to move an aircraft from a hangar or a terminal to a take-off runway), the processing unit determines, for example via the system that delivers signals representative of the penetration of the rods of the landing gears A_{A}, A_{P}into their chambers, the load exerted by the mass of the aircraft A (which is average here) on the driven wheels R_{A}. The processing unit also receives, either in the moment or in advance, the following parameters from the ground map: flexible ground with zero gradient. The weather conditions are also known to the processing unit owing to the information input by the ground crew via the human-machine interface: dry weather (dry runway).

For these conditions, the processing unit determines that the drive member is able to move the aircraft A if it is stopped for a short length of time (typically for stops in a runway queue). This information is indicated to the pilot via the human-machine interface, which displays a green light. The pilot then knows that they do not need to pre-empt the drive member being unable to move the aircraft after it has been stopped for a short length of time.

### Example 4

When the aircraft A is taxiing on a taxiway (a runway used to move an aircraft from a hangar or a terminal to a take-off runway), the processing unit determines, for example via the system that delivers a signal representative of the penetration of the rod into the chamber, the load exerted by the mass of the aircraft A (which in this case is high) on the driven wheels R^{A}. The processing unit also receives, either in the moment or in advance, the following parameters from the ground map: flexible ground with sharp upward gradient. The weather conditions are also known to the processing unit owing to the information input by the ground crew via the human-machine interface: damp weather (damp runway).

For these conditions, the processing unit determines that the maximum transmissible traction force 201 is less than the minimum required traction force 101 needed to move the aircraft A, and so the drive member is unable to move the aircraft if the aircraft A stops for a short length of time. This information is indicated to the pilot via the human-machine interface, which displays a yellow light. The pilot then knows that if there is a risk of having to stop the aircraft A, they will have to start at least one of the power plants of the aircraft so as not to delay the resumption of the movement of the aircraft after it has been stopped.

### Example 5

When the aircraft is on a taxiway, the processing unit determines a temperature of the critical elements of the drive member.

The processing unit informs the pilot, via the human-machine interface, which displays a yellow light, that the drive member is undergoing heating 301 that is substantially equal to the first predetermined threshold TC₁. The pilot then knows they will have to start their power plants G_{M} if they are to continue taxiing. The drive device continues to move the aircraft while the power plant(s) is/are starting up, and then the pilot turns off the drive device when the power plant(s) G_{M} is/are able to take over. If the drive device is not switched off by the pilot, it switches off automatically when the drive member undergoes heating 301 that is substantially equal to the second predetermined threshold TC₂. The processing unit then informs the pilot, via the human-machine interface, which displays a red light, that the drive member is unable to move the aircraft.

It goes without saying that the invention is not limited to the described embodiments but covers any variant falling under the scope of the invention as defined by the claims.

Although here the motor is an electric motor, it can be of a different type (hydraulic, etc.) .

Although here the drive device is part of the auxiliary landing gear A_{A}, it can also be part of any other landing gear, such as the main landing gears A_{P}.

The drive member can comprise a plurality of actuators, and the threshold with which the minimum required traction force 101 and/or the maximum transmissible traction force 201 is/are compared is adjusted depending on the number of available actuators.

Although here the pilot is informed about whether or not the drive member is able to move the aircraft A via a coloured light, this can also be indicated by any other means, in particular via the human-machine interface. The pilot can also be informed, for example via the human-machine interface, of the reasons why the drive member is unable to move the aircraft A (limited grip, heating of the drive member, etc.), which can allow the pilot to appropriately reconfigure the movement of said aircraft A.

For each of the airports used by the aircraft, the processing unit may store the data input by the pilot or the ground crew (slope of the ground, type of ground, etc.) in a database so that during the flights it is possible to do away with the information supplied by the pilot and/or the ground crew. The database can be shared with other aircraft.

1. A method for taxiing an aircraft by pre-empting when a drive member provided in at least one wheel born by a landing gear of the aircraft is unable to move said aircraft on the ground, the method comprising:
determining at least one of the following values: a minimum required traction force needed by the drive member to move the aircraft, a maximum transmissible traction force that can be transmitted to the ground by grip via the wheel, and heating of the drive member;
comparing each value with a predetermined threshold; and
deducing from the comparison whether the drive member is able to move the aircraft.

2. The method according to claim 1, wherein the drive member is sized so as to be able to move the aircraft only in a majority of operating scenarios.

3. The method according to claim 1, wherein the minimum required traction force is determined from at least one of the following parameters: the mass of the aircraft, the type of ground, the slope of the ground, the ambient temperature and the stop time of the aircraft.

4. The method according to claim 3, wherein the minimum required traction force is determined from charts or equations that relate the mass of the aircraft and the slope of the ground to the minimum required traction force depending on the type of ground, the ambient temperature and the stop time of the aircraft.

5. The method according to claim 1, wherein the maximum transmissible traction force that can be transmitted by grip is determined from at least one of the following parameters: a load exerted by the mass of the aircraft on the wheel, ground conditions.

6. The method according to claim 5, wherein the maximum transmissible traction force is determined from charts or equations that relate the load exerted by the mass of the aircraft on the wheel to said maximum transmissible traction force depending on the ground conditions.

7. The method according to claim 1, wherein the heating of the drive member is determined from the temperature of at least one critical element of the drive member.

8. The method according to claim 1, wherein the predetermined threshold with which the minimum required traction force is compared corresponds substantially to the maximum torque deliverable by the drive member.

9. The method according to claim 1, wherein the predetermined threshold with which the maximum transmissible traction force is compared corresponds substantially to the minimum required traction force.

10. The method according to claim 1, wherein the drive member comprises a plurality of actuators, and the predetermined threshold with which the minimum required traction force and/or the maximum transmissible traction force is/are compared is adjusted depending on the number of available actuators.
